(19) United States
(12) Patent Application Publication
(10) Pub. No.: US 2004/0240738 A1
(43) Pub. Date: Dec. 2, 2004

(54) Character recognition device, character recognition method, and recording medium

(76) Inventor: Yuji Nakajima, Matsumoto-shi (JP)

Correspondence Address: MARTINE & PENILLA, LLP, 710 LAKEWAY DRIVE, SUITE 170, SUNNYVALE, CA, 94085, US

(21) Appl. No.: 10/794,927

(22) Filed: Mar. 5, 2004

(30) Foreign Application Priority Data
Mar. 12, 2003 (JP) 2003-65890(P)

(51) Int. Cl. G06K 9/18

(52) U.S. Cl. 382/185

(57) ABSTRACT

The technique of the invention efficiently eliminates non-required portions of image data from the subject of character recognition and specifies connection of recognition areas in a linguistically correct order, thus enhancing the accuracy of recognition. The procedure of the invention specifies multiple recognition areas in image data corresponding to one page of a document and carries out character recognition in each of the multiple recognition areas. The procedure selects one of the multiple recognition areas as a target processing area and determines which of a side recognition area located on a left side or a right side of the target processing area and a lower recognition area located below the target processing area is a linguistic continuance of the target processing area. For example, a recognition frame FR4 is set to the target processing area. The last line of the recognition frame FR4 is ended with a punctuation symbol. The first line of a recognition frame FR3, which is located on the left side of the recognition frame FR4, is indented, while the first line of a recognition frame FR6, which is located below the recognition frame FR4, is not indented. The indented recognition area FR3 is thus specified as a linguistic continuance of the recognition frame FR4. A processing ordinal number allocated to the recognition frame FR3 is then changed to an ordinal number immediately after the processing ordinal number of the recognition frame FR4.

### BACKGROUND OF THE INVENTION

1. Field of the Invention

The present invention relates to a technique of specifying multiple recognition areas in image data corresponding to one page of a document and carrying out character recognition in each of the multiple recognition areas.

2. Description of the Related Art

A prior art device of optically reading a 1-page document for character recognition specifies frames of recognition areas on image data of the document and carries out character recognition in each of the frames (recognition frames). This technique eliminates non-required portions of the image data from the subject of character recognition and shortens the processing time.

The prior art technique allocates processing ordinal numbers for character recognition to the respective recognition frames. The allocation of the processing ordinal numbers simply follows an order of specification of the recognition frames or a preset rule (for example, a sequence from an upper right position to a lower left position in the case of vertical writing). This prior art technique may connect a recognition frame with a wrong recognition frame to give an awkward connection of sentences in the process of character recognition.

### SUMMARY OF THE INVENTION

The object of the present invention is thus to efficiently eliminate non-required portions of image data from the subject of character recognition and to specify connection of recognition areas in a linguistically correct order, thus enhancing the accuracy of recognition.

In order to attain at least part of the above and the other related objects, the present invention is directed to a character recognition device that specifies multiple recognition areas in image data corresponding to one page of a document and carries out character recognition in each of the multiple recognition areas. The character recognition device includes: a target processing area selection module that selects one of the multiple recognition areas as a target processing area; a first character recognition module that carries out character recognition of image data in the selected target processing area; a second character recognition module that specifies plural recognition areas located in the neighborhood of the selected target processing area as potential continuing recognition areas and carries out character recognition of image data in each of the potential continuing recognition areas; and a linguistic connection determination module that determines a linguistic connection of the target processing area with each of the potential continuing recognition areas according to a relation between a character in the target processing area recognized by the first character recognition module and a character in each potential continuing recognition area recognized by the second character recognition module, and specifies a recognition area that is a linguistic continuance of the target processing area, based on a result of the determination.

The character recognition device of the invention constructed as discussed above (hereafter referred to as the character recognition device of the fundamental structure) selects a target processing area among the multiple recognition areas specified on the image data and specifies a recognition area among the plural recognition areas located in the neighborhood of the selected target processing area as a linguistic continuance of the target processing area, based on results of recognition of the character in the target processing area and the character in each potential continuing recognition area. This arrangement enables the multiple recognition areas specified on the image data to be arranged in a linguistically correct order for character recognition. The character recognition device of the invention efficiently eliminates non-required portions of image data from the subject of character recognition and specifies connection of recognition areas in a linguistically correct order, thus enhancing the accuracy of recognition.

In one preferable embodiment of the invention, the character recognition device further has a restriction module that restricts the potential continuing recognition areas to recognition areas having an identical dimension with that of the target processing area. Here the identical dimension may be either or both of a vertical dimension and a lateral dimension of the recognition area.

This arrangement specifies connection of the recognition areas with omission of headlines from a newspaper or magazine article.

In another preferable application of the character recognition device of the fundamental structure, a recognition area located on a predetermined side between left and right sides of the target processing area and a recognition area located below the target processing area are specified as the potential continuing recognition areas.

This arrangement specifies either of the recognition area located on the predetermined side between the left and right sides of the target processing area and the recognition area located below the target processing area, as a linguistic continuance of the target processing area.

In another preferable embodiment of the invention, the character recognition device having the potential continuing recognition areas specified in the two directions further includes: a writing direction specification module that specifies a writing direction of the document as either vertical writing or horizontal writing; and a direction setting module that sets the left side to the predetermined side in the case of vertical writing specified by the writing direction specification module, while setting the right side to the predetermined side in the case of horizontal writing specified by the writing direction specification module.

This arrangement specifies connection of the recognition areas according to the writing direction of the document, either vertical writing or horizontal writing.

In still another preferable application of the character recognition device of the fundamental structure, the first character recognition module recognizes a character at an end of the image data in the target processing area, and the second character recognition module recognizes a character at a head of the image data in each of the potential continuing recognition areas.

The connection of the target processing area with each potential continuing recognition area is specified according to the relation between the character at the end of the processing target area and the character at the head of the potential continuing recognition area. This arrangement specifies a recognition area as a linguistic continuance of the target processing area with high accuracy.

In the character recognition device of the above preferable application, when the character recognized by the first character recognition module is a symbol representing termination of a sentence, the linguistic connection determination module selects a potential continuing recognition area having a blank character recognized by the second character recognition module and specifies the selected potential continuing recognition areas as the recognition area that is a linguistic continuance of the target processing area.

The linguistic connection of the potential continuing recognition area with the target processing area is assured, when the last line of the target processing area is ended with a symbol representing termination of a sentence and the potential continuing recognition area is indented and has a blank character at the head thereof. This arrangement specifies a recognition area as a linguistic continuance of the target processing area with high accuracy.

In the character recognition device of the above preferable application, when the character recognized by the first character recognition module is not a symbol representing termination of a sentence and is located at an edge of the target processing area, the linguistic connection determination module selects a potential continuing recognition area having a character other than a blank character recognized by the second character recognition module and specifies the selected potential continuing recognition areas as the recognition area that is a linguistic continuance of the target processing area.

The linguistic connection of the potential continuing recognition area with the target processing area is assured, when the last line of the target processing area is not ended with a symbol representing termination of a sentence but continues to the edge of the target processing area and the potential continuing recognition area is not indented and does not have a blank character at the head thereof. This arrangement specifies a recognition area as a linguistic continuance of the target processing area with high accuracy.

In another preferable application of the character recognition device of the fundamental structure, the first character recognition module recognizes a character string in at least a preset rear range of the image data in the target processing area, and the second character recognition module recognizes a character string in at least a preset front range of the image data in each of the potential continuing recognition areas. The linguistic connection determination module has a syntax analysis sub-module that tentatively connects the character string recognized by the first character recognition module with the character string recognized by the second character recognition module and analyzes a syntax of the character strings including the connection, so as to determine a linguistic connection of the target processing area with each of the potential continuing recognition areas.

The linguistic connection of each potential continuing recognition area with the target processing area is determined, based on a result of the syntax analysis. This arrangement specifies a recognition area as a linguistic continuance of the target processing area with high accuracy.

In the character recognition device of the above preferable application, the linguistic connection determination module further has a presence determination sub-module that, when an end of the character string recognized by the first character recognition module is not a symbol representing termination of a sentence but is located at an edge of the target processing area, determines whether there is any potential continuing recognition area having a character other than a blank character at a head of the character string recognized by the second character recognition module. The syntax analysis sub-module is activated when it is determined that there is no potential continuing recognition area by the presence determination sub-module.

The character recognition device of this structure preferentially specifies the connection of the recognition areas, based on a simple combination of a symbol representing termination of a sentence at the end with a blank character at the head. When no such relation is observed, the syntax analysis is carried out. This arrangement gives priority to the simple specification and secondarily performs the complicated syntax analysis, thus desirably shortening the total processing time.

In another preferable embodiment of the invention, the character recognition device of the fundamental structure further includes: a processing order data storage module that stores data for defining a processing order of character recognition of the multiple recognition areas; and a processing order adjustment module that modifies the data to adjust the processing order, based on a result of the determination by the linguistic connection determination module. The target processing area selection module successively changes selection of the target processing area in the processing order defined by the data stored in the processing order data storage module.

In the structure of this embodiment, as the target processing area selection module successively changes selection of the target processing area in the processing order defined by the data stored in the processing order data storage module, the connection specification module specifies a recognition area as a linguistic continuance of each target processing area. The processing order is adjusted, based on the result of each determination by the linguistic connection determination module. In this manner, all the recognition areas specified on the image data are rearranged in a linguistically correct order.

The present invention is also directed to a character recognition method that specifies multiple recognition areas in image data corresponding to one page of a document and carries out character recognition in each of the multiple recognition areas. The character recognition method includes the steps of: (a) selecting one of the multiple recognition areas as a target processing area; (b) carrying out character recognition of image data in the selected target processing area; (c) specifying plural recognition areas located in the neighborhood of the selected target processing area as potential continuing recognition areas and carrying out character recognition of image data in each of the potential continuing recognition areas; and (d) determining a linguistic connection of the target processing area with each of the potential continuing recognition areas according to a relation between a character in the target processing area recognized in the step (b) and a character in each potential continuing recognition area recognized in the step (c), and specifying a recognition area that is a linguistic continuance of the target processing area, based on a result of the determination.

The invention is further directed to a recording medium in which a computer program is recorded in a computer readable manner. The computer program is executed to specify multiple recognition areas in image data corresponding to one page of a document and to carry out character recognition in each of the multiple recognition areas. The computer program causes a computer to attain the functions of: (a) selecting one of the multiple recognition areas as a target processing area; (b) carrying out character recognition of image data in the selected target processing area; (c) specifying plural recognition areas located in the neighborhood of the selected target processing area as potential continuing recognition areas and carrying out character recognition of image data in each of the potential continuing recognition areas; and (d) determining a linguistic connection of the target processing area with each of the potential continuing recognition areas according to a relation between a character in the target processing area recognized in the function (b) and a character in each potential continuing recognition area recognized in the function (c), and specifying a recognition area that is a linguistic continuance of the target processing area, based on a result of the determination.

The character recognition method and the recording medium of the invention have similar functions and effects to those of the character recognition device of the invention described above. The character recognition method and the computer program of the invention efficiently eliminate non-required portions of image data from the subject of character recognition and specify connection of recognition areas in a linguistically correct order, thus enhancing the accuracy of recognition.

The technique of the present invention may be attained by other applications. The first application is a computer program recorded in the recording medium described above. The second application is a program supply device that supplies the computer program via a communication line. In the second application, computer programs are stored, for example, in a server on a computer network. A computer downloads a required computer program via the communication line and executes the downloaded computer program to attain the character recognition device and the character recognition method discussed above.

These and other objects, features, aspects, and advantages of the present invention will become more apparent from the following detailed description of the preferred embodiment with the accompanying drawings.

### BRIEF DESCRIPTION OF THE DRAWINGS

FIG. 1 is a block diagram schematically illustrating the hardware configuration of a computer system in one embodiment of the invention;

FIG. 2 shows image data SD of a scanned image input by a scanned image input module;

FIG. 3 shows the image data SD with recognition frames FR1 through FR10 specified by a recognition area specification sub-module;

FIG. 4 shows a recognition frame table FRT storing data of the recognition frames FR1 through FR10;

FIG. 5 is a flowchart showing a first half of the processing order adjustment routine executed by the CPU of a computer main unit;

FIG. 6 is a flowchart showing a second half of the processing order adjustment routine;

FIG. 7 shows the image data SD with processing ordinal numbers reallocated by the processing order adjustment routine of FIGS. 5 and 6; and

FIG. 8 shows image data SD2 of an English document with recognition frames FR11 through FR15.

### DESCRIPTION OF THE PREFERRED EMBODIMENTS

One mode of carrying out the invention is discussed below in the following sequence:

A. Hardware Configuration

B. Software Configuration

C. Functions and Effects

D. Modified Examples

A. Hardware Configuration

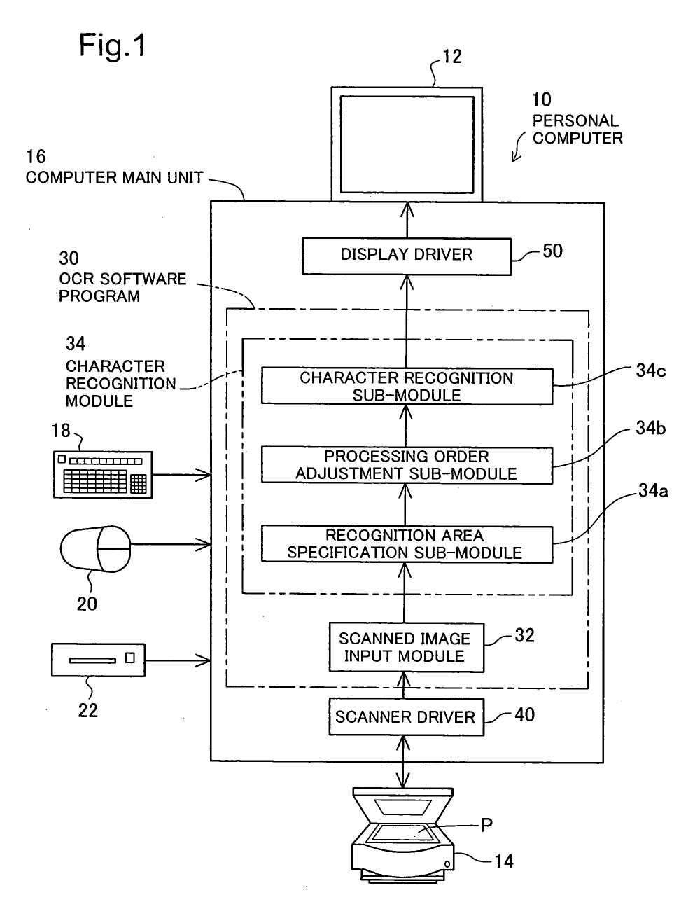

FIG. 1 is a block diagram schematically illustrating the hardware configuration of a computer system in one embodiment of the invention. The computer system includes a personal computer 10 as its center and a liquid crystal display 12 and an image scanner 14 as peripheral equipment. The personal computer 10 has a computer main unit 16, a keyboard 18, and a mouse 20. The computer main unit 16 has a CD drive 22 for reading the storage of each CD-ROM.

The computer main unit 16 includes a CPU, a ROM, a RAM, a display image memory, a mouse interface, and a keyboard interface, which are mutually connected via a bus. The computer main unit 16 also has a built-in hard disk drive (HDD). Image data of a document optically read by the image scanner 14 are temporarily stored in the HDD.

The computer main unit 16 reads image data corresponding to one page of the document optically read by the image scanner 14, specifies multiple recognition areas in the image data, and carries out character recognition in each of the multiple recognition areas. The CPU of the computer main unit 16 executes an OCR (optical character reader) software program (computer program) 30, which is installed in the computer main unit 16 and is stored in the HDD, to attain a series of character recognition process. This OCR software program 30 is provided in the form of a CD-ROM.

The OCR software program 30 may be provided in the form of any other portable recording medium (transportable recording medium), such as a flexible disk, a magneto-optic disc, or an IC card, instead of the CD-ROM. The OCR software program 30 may otherwise be supplied from a specific server via a network, for example, the Internet. The OCR software program 30 may be a computer program downloaded from a certain home page on the Internet or may be a computer program obtained in the form of an attached file to an E-mail.

B. Software Configuration

The functional blocks of the computer main body 16 are also shown in FIG. 1. The OCR software program 30 installed and executed in the computer main unit 16 includes a scanned image input module 32 and a character recognition module 34 as functional blocks. The scanned image input module 32 included in the OCR software program 30 activates a scanner driver 40 to input a scanned image corresponding to one page of a document P taken by the image scanner 14. The character recognition module 34 recognizes characters in the image data of the input scanned image.

The character recognition module 34 has a recognition area specification sub-module 34a, a processing order adjustment sub-module 34b, and a character recognition sub-module 34c. The recognition area specification sub-module 34a specifies multiple recognition areas on the input image data. Ordinal numbers representing an order of recognition process (hereafter referred to as the processing ordinal numbers) are internally allocated to the respective specified recognition areas. The processing order adjustment sub-module 34b determines which recognition area is a linguistic continuance of each recognition area based on the grammatical construction and reallocates the processing ordinal numbers to the multiple recognition areas. The character recognition sub-module 34c recognizes characters in each of the multiple recognition areas in the order of the reallocated processing ordinal numbers. The character recognition gives data of character strings (text data) written on the document P. A display driver 50 then functions to send the text data to the liquid crystal display 12 for a display.

The CPU of the computer main unit 16 executes the OCR software program 30 to attain the scanned image input module 32 and the character recognition module 34 discussed above. The scanned image input module 32 has the known functions discussed above and is not specifically described here in detail. The recognition area specification sub-module 34a of the character recognition module 34 specifies multiple frames representing recognition areas (hereafter referred to as recognition frames) on the image data of the scanned image input by the scanned image input module 32. There are a manual recognition frame specification method and an auto recognition frame specification method.

The manual recognition frame specification method causes the operator to successively draw recognition frames with the mouse 20. The operator manipulates the mouse 20 to successively draw rectangular frames, which represent target areas of recognition, on the image data of the scanned image displayed in an application window on the liquid crystal display 12. The computer main unit 16 stores the successively drawn rectangular frames as recognition frames.

The auto recognition frame specification method utilizes an auto area extraction function to draw multiple recognition frames at once. The automatic recognition frame specification is triggered, in response to the operator's click of an ‘Auto Area Extract’ button in the application window with the mouse 20. The auto area extraction function extracts character areas including character strings from the image data and specifies rectangular frames surrounding the extracted character areas as recognition frames. When the image data includes a graphic area or a tabular area, the environment settings may be specified to extract a graphic or a table as an independent area or to recognize a graphic or a table as part of a character area.

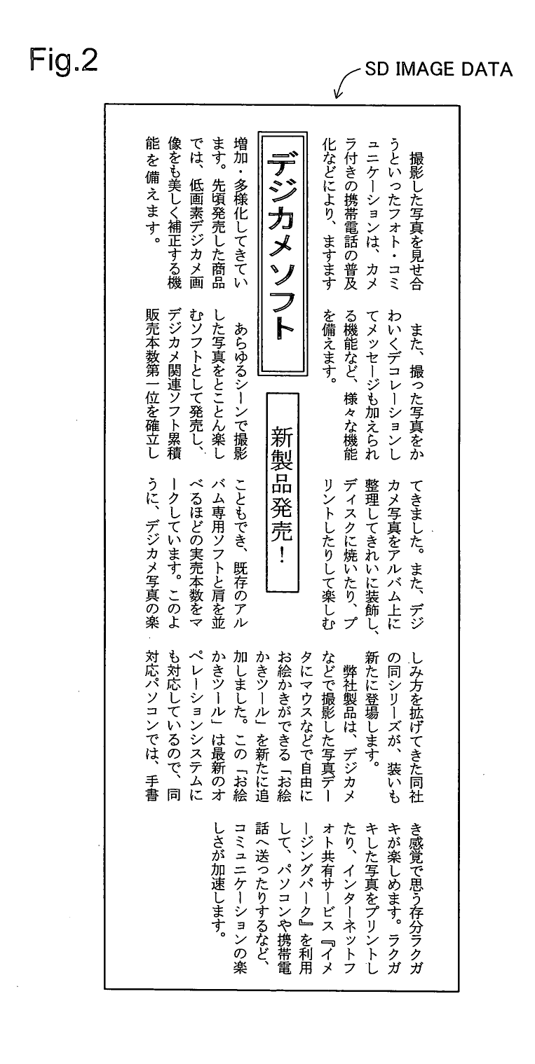

FIG. 2 shows image data SD of a scanned image input by the scanned image input module 32. A document P as an original of the scanned image is a clipping from a Japanese newspaper and is a five-column article written in a vertical direction. The first through the third columns are divided into two sections by headlines arranged in the vertical direction on the center. The headlines are captions for a quick glance of the article.

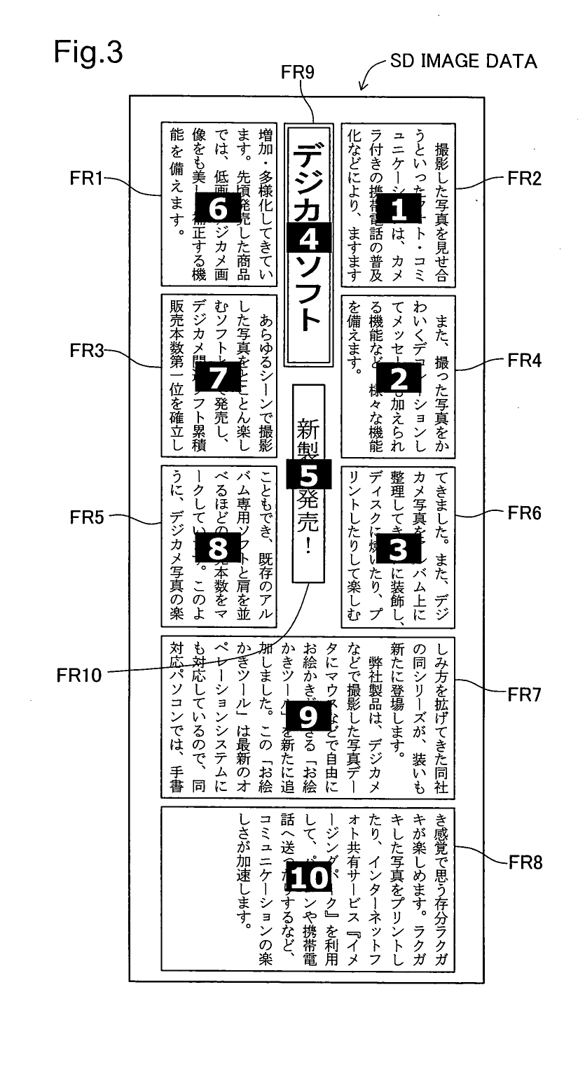

FIG. 3 shows the image data SD with recognition frames specified by the recognition area specification sub-module 34a. As illustrated, ten recognition frames FR1 through FR10, which surround character areas of character strings, are specified on the image data SD. These recognition frames FR1 through FR10 are specified by the auto recognition frame specification method in this embodiment, although the manual recognition frame specification method may be adopted instead. The first column has two recognition frames FR1 and FR2, the second column has two recognition frames FR3 and FR4, and the third column has two recognition frames FR5 and FR6. The fourth column has one recognition frame FR7 and the fifth column has one recognition frame FR8. Two recognition frames FR9 and FR10 are arranged in the vertical direction on the center of the first through the third columns.

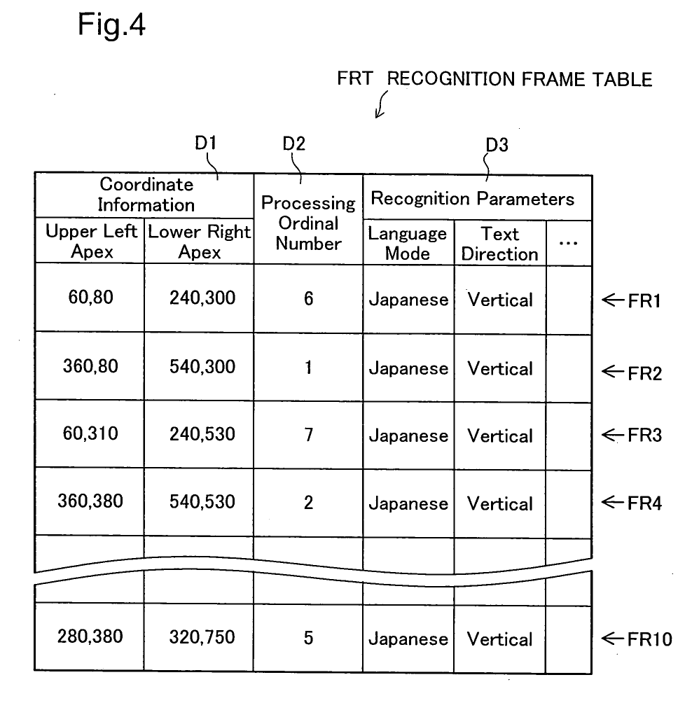

The numerals ‘1’ through ‘10’ shown on the respective centers of the recognition frames FR1 through FR10 represent the processing ordinal numbers internally allocated to the respective recognition frames FR1 through FR10 by the recognition area specification sub-module 34a. FIG. 4 shows a recognition frame table FRT storing data of the recognition frames FR1 through FR10. The recognition frame table FRT stores information with regard to the respective recognition frames FR1 through FR10 as tabular data.

Each row in the recognition frame table FRT includes coordinate information D1 regarding the corresponding recognition frame FRn (where n is a positive integral number), a processing ordinal number D2, and recognition parameters D3. The coordinate information D1 includes coordinate data of upper left and lower right apexes (that is, two apexes on a diagonal) defining the corresponding recognition frame FRn on the image data SD. The processing ordinal number D2 is numerical data and corresponds to one of ten numerals ‘1’ through ‘10’ in the illustrated example of FIG. 3. The recognition parameters D3 are specified for each recognition area and include, for example, a language mode of Japanese, English, or Mixture and a writing direction of either a vertical direction or a horizontal direction.

In the case of manual specification of the recognition frames, the processing ordinal numbers D2 are allocated to the recognition frames in the order of specification. In the case of auto specification of the recognition frames, on the other hand, the processing ordinal numbers D2 are allocated to the recognition frames in a preset positional order. The preset positional order goes from the upper right position to the lower left position in the document written in the vertical direction. In the illustrated example of FIG. 3, the processing ordinal numbers ‘1’ through ‘3’ are allocated to the recognition frames FR2, FR4, and FR6, which are located on the first through the third columns parted by the recognition frames FR9 and FR10 of the headlines and are arranged on the right side of the headlines. The auto recognition frame specification method then allocates the processing ordinal numbers ‘4’ and ‘5’ to the recognition frames FR9 and FR10 of the headlines and the subsequent processing ordinal numbers ‘6’ through ‘8’ to the recognition frames FR1, FR3, and FR5 arranged on the left side of the headlines. The auto recognition frame specification method subsequently allocates the processing ordinal numbers ‘9’ and ‘10’ to the recognition frame FR7 on the fourth column and the recognition frame FR8 on the fifth column. The preset positional order goes from the upper left position to the lower right position in the document written in the horizontal direction.

The recognition parameters D3 represent the operator's entries in an ‘Environment Settings’ dialog box (not shown). Different settings of the recognition parameters D3 may be specified for the respective recognition frames FR1 through FR10. The operator double clicks the mouse 20 in each target of the recognition frames FR1 through FR10 for setting the parameters to open a dialog box (not shown) and enters the language mode and the writing direction. The operator's entries are then set as the recognition parameters D3 for each target of the recognition frames FR1 through FR10.

The recognition frame table FRT having the above structure is stored in the RAM of the computer main unit 16. The processing ordinal numbers D2 in the recognition frame table FRT are changed according to the requirements by the functions of the processing order adjustment sub-routine 34b, as described later.

The character recognition sub-module 34c refers to the recognition frame table FRT and recognizes characters included in the image data SD of the input scanned image. The character recognition sub-module 34c refers to the coordinate information D1 stored in the recognition frame table FRT, extracts each target recognition frame on the image data SD, and carries out character recognition in each extracted target recognition frame. The order of extraction of the target recognition frames follows the processing ordinal numbers D2 allocated to the recognition frames and stored in the recognition frame table FRT. The character recognition successively compares each character of the input image data with characters included in a character dictionary stored in the HDD and selects a character having the highest degree of coincidence as a result of character recognition, as is well known in the art.

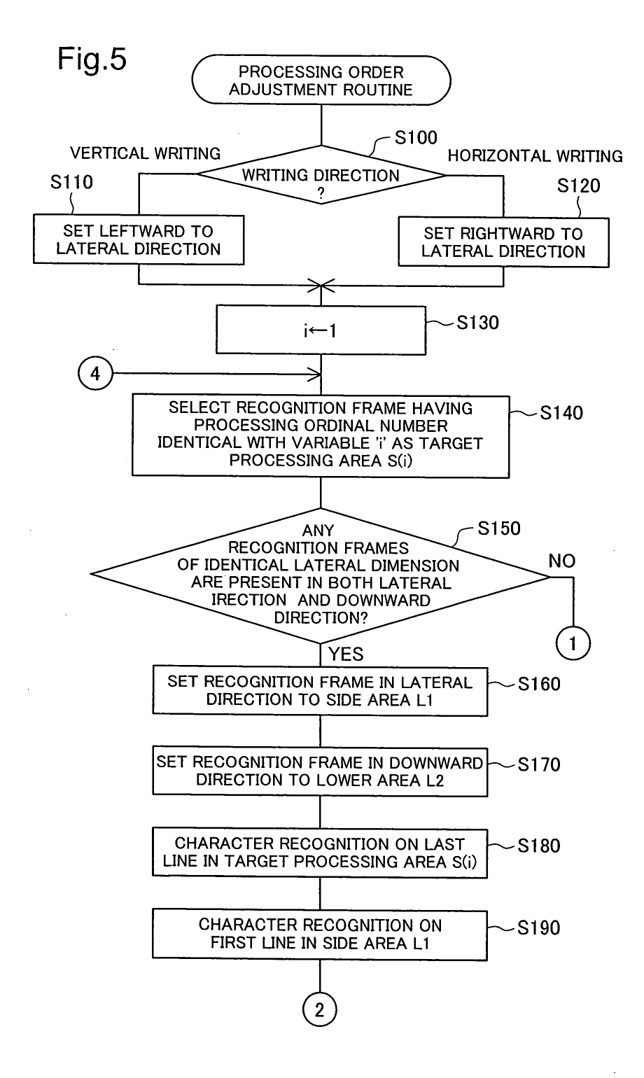

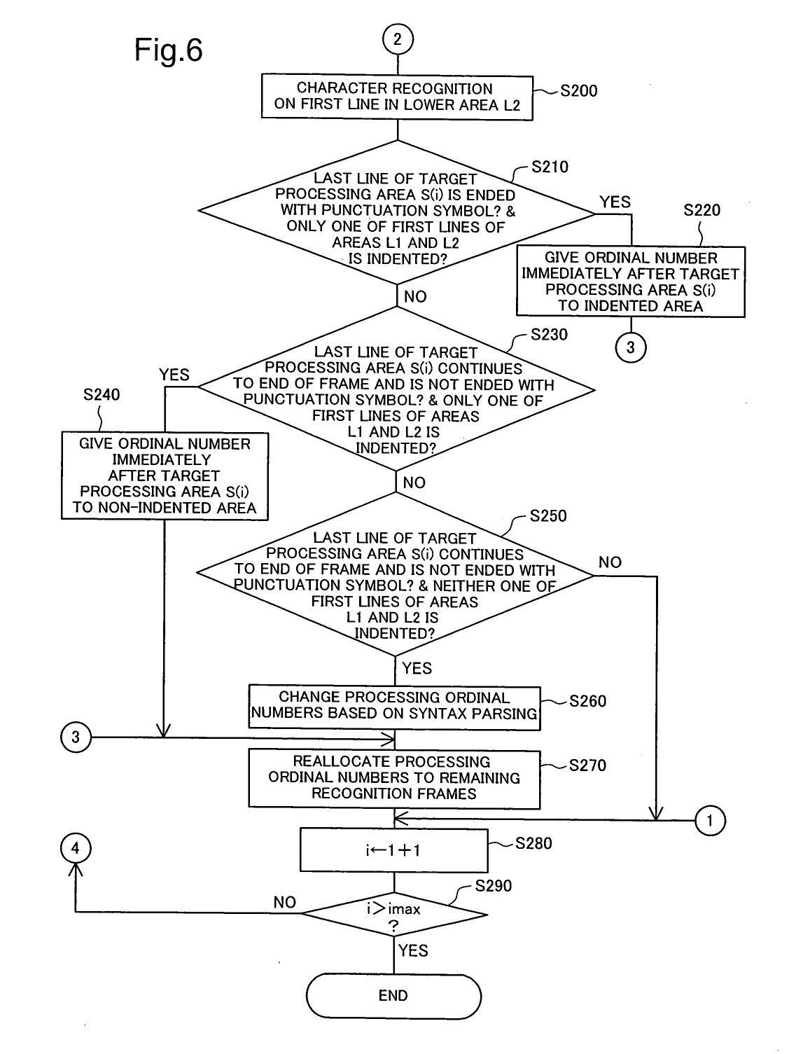

The processing order adjustment sub-module 34b is described in detail. The CPU of the computer main unit 16 executes a control routine (processing order adjustment routine) as part of the OCR software program 30 to attain the functions of the processing order adjustment sub-module 34b. FIGS. 5 and 6 are flowcharts showing this processing order adjustment routine. This routine is activated on conclusion of the auto recognition frame specification process, which is triggered in response to the operator's click of the ‘Auto Area Extract’ button with the mouse 20. This embodiment does not execute the processing order adjustment routine in the case of selection of the manual recognition frame specification process.

When the processing order adjustment routine starts, the CPU of the computer main unit 16 first determines whether a target document for character recognition is written in the vertical direction or in the horizontal direction, based on information regarding the writing direction (step S100). The information regarding the writing direction represents the operator's entry in a ‘Writing Direction’ input box in the ‘Environment Settings’ dialog box (not shown) with the mouse 20. In one possible modification, the CPU may carry out preview character recognition and automatically select either vertical writing or horizontal writing, in response to the operator's activation of an ‘Auto Detection’ mode.

When it is determined at step S100 that the target document is written in the vertical direction, the CPU sets ‘leftward’ to ‘lateral direction’ (discussed later) (step S110). When it is determined at step S100 that the target document is written in the horizontal direction, on the other hand, the CPU sets ‘rightward’ to the ‘lateral direction’ (step S120). After execution of either step S110 or step S120, the CPU sets a value ‘1’ to a variable ‘i’ (step S130).

The CPU subsequently searches the recognition frame table FRT to select a recognition frame having the processing ordinal number D2 identical with the variable ‘i’ as a target processing area S(i) among the recognition frames FR1 through FR10 (step S140). The CPU then determines whether the selected target processing area S(i) has any recognition frames having an identical lateral dimension with that of the target processing area S(i) both in the downward direction and in the lateral direction set at step S110 on the image data SD (step S150). The determination is based on the coordinate information D1 stored in the recognition frame table FRT. The procedure refers to only the lateral dimension of the recognition frames, since the respective columns are set to have substantially the same vertical dimension in the newspaper. The processing of step S150 may specify the presence of any recognition frames having both identical lateral and vertical dimensions with those of the target processing area S(i) or having only an identical vertical dimension, according to the layout of the target document.

In the illustrated example of FIG. 3, when the variable ‘i’=1, the target processing area S(1) is the recognition frame FR2 located on the right side of the first column. The recognition frame FR1 (having the identical lateral dimension) located on the left side of the first column is present in the lateral direction (in the leftward direction in the case of vertical writing) of the target processing area S(1). The recognition frame FR4 (having the identical lateral dimension) located on the right side of the second column is present in the downward direction of the target processing area S(1). An affirmative answer is accordingly given at step S150. The recognition frames may be adjacent to or may not be adjacent to the target processing area S(i) in both the lateral direction and in the vertical direction. The recognition frame FR4 is adjacent to the recognition frame FR2 as the target processing area S(i), whereas the recognition frame FR1 is not adjacent to the recognition frame FR2 but the recognition frame FR9 of another lateral dimension is located between the recognition frames FR1 and FR2. In the illustrated example of FIG. 3, the recognition frames FR1 through FR6 parted by the recognition frames FR9 and FR10 of the headlines are accordingly subjected to a subsequent connection judgment.

Referring back to the flowchart of FIG. 5, in the case of an affirmative answer at step S150, the routine proceeds to step S160. In the case of a negative answer at step S150, on the other hand, the routine proceeds to step S280 in the flowchart of FIG. 6 to increment the variable ‘i’ by one. The variable ‘i’ is then compared with the total number of recognition frames ‘imax’ (=10 in the illustrated example of FIG. 3) (step S290). When the variable ‘i’ is not greater than the total number of recognition frames ‘imax’ at step S290, the routine returns to step S140 in the flowchart of FIG. 5. The processing order adjustment routine changes the processing ordinal numbers allocated to the recognition frames only when recognition frames of the identical lateral dimension are present in both the lateral direction and the downward direction of the target processing area S(i) as described below. Otherwise the processing order adjustment routine shifts the object of processing to a next target processing area S(i+1) without changing the processing ordinal numbers. In the illustrated example, when the target processing area S(i) is any one of the left recognition frames FR1, FR3, and FR5 on the first through the third columns and the recognition frames FR7 and FR8 on the fourth and the fifth columns, no recognition frame is present in the lateral direction. The processing order adjustment routine thus skips the processing to change the processing ordinal numbers.

At step S160, the CPU sets the recognition frame in the lateral direction, which is determined to be present at step S150, to a side area L1. When there are multiple recognition frames of the identical lateral dimension in the lateral direction, the recognition frame closest to the target processing area S(i) is selected as the side area L1. The CPU subsequently sets the recognition frame in the downward direction, which is determined to be present at step S150, to a lower area L2 (step S170). The side area L1 and the lower area L2 correspond to the potential continuing recognition areas of the invention. The subsequent steps are executed to determine the connection of the recognition areas other than those of the headlines.

The CPU successively carries out character recognition on the last line of the image data SD in the target processing area S(i) selected at step S140 (step S180), character recognition on the first line of the image data SD in the side area L1 set at step S160 (step S190), and character recognition on the first line of the image data SD in the lower area L2 set at step S170 (step S200 in the flowchart of FIG. 6).

Based on the results of character recognition carried out at steps S180, S190, and S200, the CPU determines whether the last line of the processing target area S(i) is ended with a punctuation symbol and whether only one of the first lines of the side area L1 and the lower area L2 is indented (step S210). The former condition determines whether the end letter of the target processing area S(i) is a punctuation symbol. The latter condition determines whether the first letter of either the side area L1 or the lower area L2 is a blank character (space). Here the punctuation symbol represents termination of each sentence used in Japanese language and is a small open circle. This punctuation symbol is found, for example, at the end of the left-most line in the recognition frame FR1 in the illustrated example of FIG. 3. When both the conditions are fulfilled and an affirmative answer is given at step S210, the CPU specifies the area having an indent (indented area) as a linguistic continuance of the target processing area S(i) and changes the processing ordinal number D2 of the indented area stored in the recognition frame table FRT to the sum of the variable ‘i’ and 1 (step S220). This changes the processing ordinal number D2 of the indented area to the processing ordinal number immediately after the variable ‘i’. When the document P is written in English, the punctuation symbol is replaced by any of symbols representing termination of each sentence, for example, a period ‘.’, an exclamation mark ‘!’, a semicolon ‘;’, a colon ‘:’, and a question mark ‘?’.

In the illustrated example of FIG. 3, when the target processing area S(i) is the recognition frame FR4, the last line of the recognition frame FR4 is ended with a punctuation symbol. The first line of the recognition frame FR3, which is located in the lateral direction of the recognition frame FR4 and is set to the side area L1, is indented, while the first line of the recognition frame FR6, which is located in the downward direction of the recognition frame FR4 and is set to the lower area L2, is not indented. The indented recognition area FR3 is thus specified as a linguistic continuance of the recognition frame FR4. The processing ordinal number D2 of the recognition frame FR3 stored in the recognition frame table FRT is then changed to ‘i+1’. The processing ordinal number D2 of the recognition frame FR4 has already been changed to ‘3’ in a previous cycle of this routine (see steps S230 and S240, and S270 discussed below). When the recognition frame FR4 is the target processing area S(i), the processing ordinal number D2 of the recognition frame FR3 is thus changed to the value ‘i=3’+‘1’=‘4’

After execution of step S220, the processing order adjustment routine proceeds to step S270 to reallocate the processing ordinal numbers to the remaining recognition frames having the processing ordinal numbers later than the sum of the variable ‘i’ and 1. The reallocation here follows the method of allocation of the processing ordinal numbers executed by the recognition area specification sub-module 34a. Namely the processing order goes from the upper right position to the lower left position in the case of vertical writing, while going from the upper left position to the lower right position in the case of horizontal writing. After the reallocation at step S270, the processing order adjustment routine goes to step S280 to increment the variable ‘i’ as discussed above.

In the case of a negative answer at step S210, the CPU goes to step S230 to determine whether the last line of the target processing area S(i) continues to the edge of the frame (that is, whether the end of the last line coincides with the end of the target processing area S(i)) and is not ended with a punctuation symbol and whether only one of the first lines of the side area L1 and the lower area L2 is indented, based on the results of character recognition at steps S180 through S200. When both the conditions are fulfilled and an affirmative answer is given at step S230, the CPU specifies the area having no indent (non-indented area) as a linguistic continuance of the target processing area S(i) and changes the processing ordinal number D2 of the non-indented area stored in the recognition frame table FRT to the sum of the variable ‘i’ and 1 (step S240). This changes the processing ordinal number D2 of the non-indented area to the processing ordinal number immediately after the variable ‘i’.

In the illustrated example of FIG. 3, when the target processing area S(i) is the recognition frame FR2, the last line of the recognition frame FR2 continues to the edge of the frame and is not ended with a punctuation symbol. The first line of the recognition frame FR1, which is located in the lateral direction of the recognition frame FR2 and is set to the side area L1, is not indented, while the first line of the recognition frame FR4, which is located in the downward direction of the recognition frame FR2 and is set to the lower area L2, is indented. The non-indented recognition area FR1 is thus specified as a linguistic continuance of the recognition frame FR2. The processing ordinal number D2 of the recognition frame FR1 stored in the recognition frame table FRT is then changed to ‘i+1’. When the recognition frame FR2 is the target processing area S(i), the processing ordinal number D2 of the recognition frame FR1 is changed to the value ‘i=1’+‘1’=‘2’

After execution of step S240, the processing order adjustment routine proceeds to step S270 to reallocate the processing ordinal numbers to the remaining recognition frames having the processing ordinal numbers later than the sum of the variable ‘i’ and 1 as described above. In the case of a negative answer step S230, the processing order adjustment routine goes to step S250.

At step S250, the CPU determines whether the last line of the target processing area S(i) continues to the edge of the frame (that is, whether the end of the last line coincides with the end of the target processing area S(i)) and is not ended with a punctuation symbol and whether neither one of the first lines of the side area L1 and the lower area L2 is indented, based on the results of character recognition at steps S180 through S200. When both the conditions are fulfilled and an affirmative answer is given at step S250, the processing order adjustment routine goes to step S260.

At step S250, the CPU parses the connection of the target processing area S(i) with the side area L1 and the connection of the target processing area S(i) with the lower area L2. When only one of the syntaxes is correct, the CPU specifies the side area L1 or the lower area L2 having the correct syntax as a linguistic continuance of the target processing area S(i) and changes the processing ordinal number D2 of the side area L1 or the lower area L2 of the correct syntax stored in the recognition frame table FRT to the sum of the variable ‘i’ and 1. This changes the processing ordinal number D2 of the side area L1 or the lower area L2 having the correct syntax to the processing ordinal number immediately after the variable ‘i’.

The procedure of parsing divides an input text into minimum linguistic units called morphemes, joins the morphemes to clauses, and analyzes the syntax. A word dictionary including all the parts of speech is used for division into morphemes. The analysis of the syntax parses the modification relation of the clauses, based on a rule dictionary of parsing. The word dictionary and the rule dictionary are stored in advance in the HDD as mentioned previously.

The modification relation of the clauses is determined by specifying the type of a clause modified by each clause and the type of a clause modifying each clause. The procedure of syntax analysis parses the modification relation of the clauses and evaluates the closeness of the modification of the clauses, that is, the closeness of the conjuncture of the clauses. The concrete technique of the syntax analysis is known in the art and is not specifically described here. The correct syntax is selected, based on the result of the evaluation. The processing of step S260 tentatively connects the side area L1 (or the lower area L2) with the target processing area S(i), extracts a character string including a preset number of characters including the connection, and analyzes the syntax of the extracted character string as the input text. The method of syntax analysis is not restricted to the above description, but any technique is applicable to analyze the syntax. The input text may not be a character string including a preset number of characters but may be a character string of an adequate clause or a character string of an adequate sentence. When the document P is written in English, the syntax analysis for English language is naturally adopted.

After execution of step S260, the processing order adjustment routine proceeds to step S270 to reallocate the processing ordinal numbers to the remaining recognition frames having the processing ordinal numbers later than the sum of the variable ‘i’ and 1 as described above. In the case of a negative answer step S250, the processing order adjustment routine skips the processing of steps S260 and S270 and goes to step S280.

When the variable ‘i’ exceeds the total number of recognition frames ‘imax’ at step S290, adjustment of the processing order has been completed for all the recognition areas specified by the recognition area specification sub-module 34a. The processing order adjustment routine thus goes to ‘End’ and is terminated.

The CPU itself and the processing of step S140 executed by the CPU constitute the target processing area selection module of the invention. The CPU itself and the processing of steps S180 executed by the CPU constitute the first character recognition module of the invention. The CPU itself and the processing of steps S150, S160, S170, S190 and S200 executed by the CPU constitute the second character recognition module of the invention. The CPU itself and the processing of S210 through S260 executed by the CPU constitute the linguistic connection determination module of the invention.

C. Functions and Effects

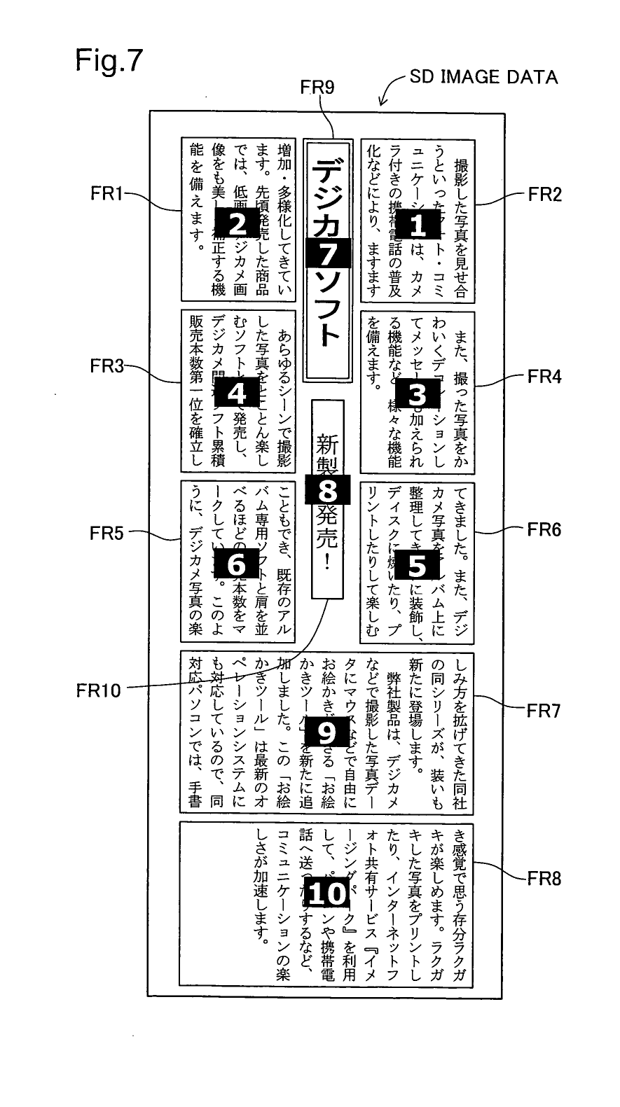

FIG. 7 shows the image data SD with the processing ordinal numbers reallocated by the processing order adjustment routine discussed above. As illustrated, the processing ordinal numbers ‘2’, ‘3’, ‘4’, ‘5’, and ‘6’ are respectively reallocated to the recognition frame FR1 arranged on the left side of the first column, the recognition frame FR4 arranged on the right side of the second column, the recognition frame FR3 arranged on the left side of the second column, the recognition frame FR6 arranged on the right side of the third column, and the recognition frame FR5 arranged on the left side of the third column. After the change of the processing ordinal number of the recognition frame FR5 to ‘6’, the processing ordinal numbers ‘7’ and ‘8’ are reallocated to the remaining recognition frames FR9 and FR10 of the headlines at step S270.

The reallocated processing ordinal numbers connect the recognition areas in a linguistically right order. The resulting text data generated by the character recognition sub-module 34c accordingly has the high accuracy of recognition. The procedure of this embodiment specifies the connection of the target processing area with each potential continuing recognition area, based on the relation between the end of the target processing area and the head of the potential continuing recognition area. This arrangement determines which recognition area is a linguistic continuance of the target processing area with high accuracy.

One relation between the end of the target processing area and the head of the potential continuing recognition area is combination of a punctuation symbol at the end of the target processing area with the indented potential continuing recognition area having a blank character at its head. In another relation, the last line of the target processing area continues to the edge of the frame and is not ended with a punctuation symbol, while the potential continuing recognition area does not have a blank character at the head and is not indented. Based on such relations, the linguistic connection of the recognition areas is specified with high accuracy.

The procedure of this embodiment tentatively connects the last character of the target processing area with the head of each potential continuing recognition area and parses the character string including the connection. The connection of the recognition areas is then specified, based on the results of parsing. This arrangement ensures specification of the linguistic connection of the recognition areas with high accuracy. The procedure of the embodiment preferentially specifies the connection of the recognition areas, based on simple combination of a punctuation symbol at the end with a blank character at the head. When no such relation is observed, the syntax analysis is carried out. This arrangement gives priority to the simple specification and secondarily performs the complicated syntax analysis, thus desirably shortening the total processing time.

In the embodiment discussed above, the document P is written in the vertical direction. The procedure of the embodiment is, however, also applicable to horizontal writing. In the latter case, the rightward direction is set to the lateral direction at step S120 in the flowchart of FIG. 5. The processing routine linguistically connects the recognition areas and gives the accurate character string data for the document written in the horizontal direction.

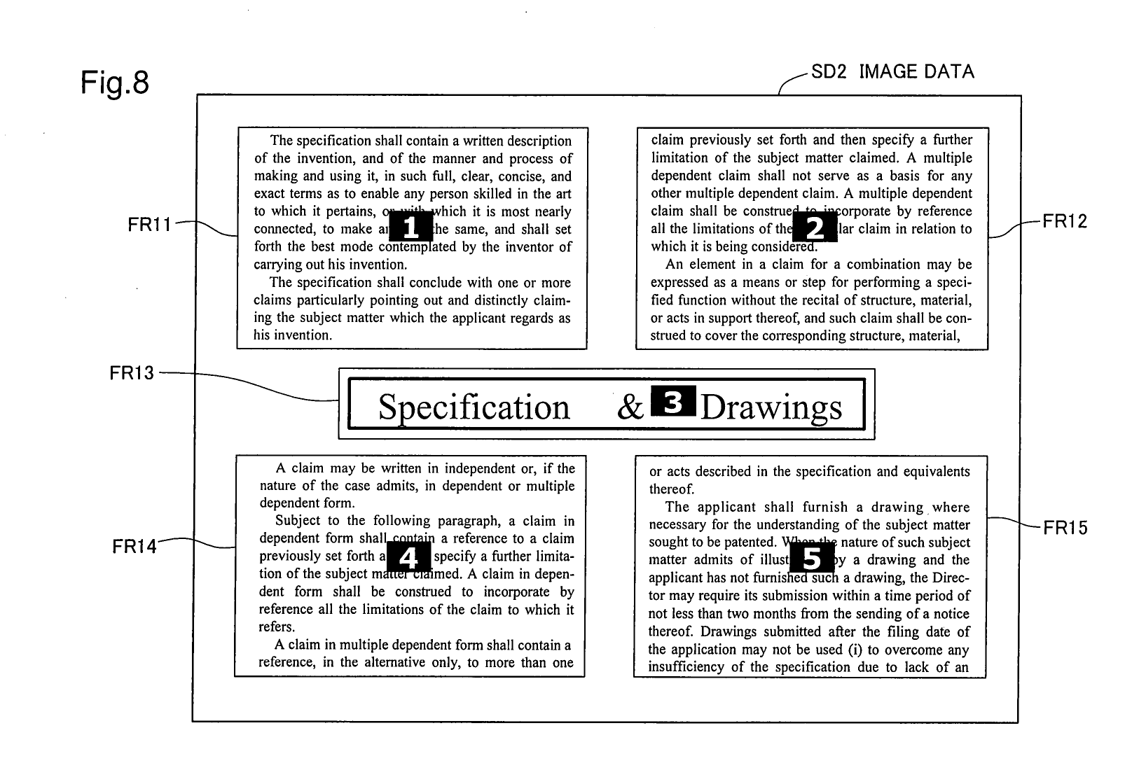

The above embodiment regards the Japanese document P. The technique of the embodiment is also applicable to an English document. FIG. 8 shows image data SD2 of an English document with recognition frames FR11 through FR15. In the illustrated example of FIG. 8, five recognition frames FR11 through FR15 surrounding character areas of character strings are specified on the image data SD2. The first column has two recognition frames FR11 and FR12, the second column has one recognition frame FR13, and the third column has two recognition frames FR14 and FR15. The numerals ‘1’ through ‘5’ shown on the respective centers of the recognition frames FR11 through FR15 represent the processing ordinal numbers internally allocated to the respective recognition frames FR11 through FR15.

When the image data SD2 goes through the processing order adjustment routine of FIGS. 5 and 6, the CPU specifies horizontal writing at step S100 and sets the rightward direction to the lateral direction at step S120. Determination at steps S210, S230, and S250 in the flowchart of FIG. 6 is based on any of the symbols representing termination of each sentence in English, for example, a period ‘.’, an exclamation mark ‘!’, a semicolon ‘;’, a colon ‘:’, and a question mark ‘?’, instead of the punctuation symbol in Japanese.

In the illustrated example of FIG. 8, when the target processing area S(i) is the recognition frame FR11, the last line of the target processing area S(i) is ended with a period ‘.’. The first line of the recognition frame FR12, which is located in the lateral direction of the recognition frame FR11 and is set to the side area L1, is not indented, while the first line of the recognition frame FR14, which is located in the downward direction of the recognition frame FR11 and is set to the lower area L2, is indented. The indented recognition frame FR14 is accordingly specified as a linguistic continuance of the recognition frame FR11. The processing ordinal numbers stored in the recognition frame table FRT are then reallocated to the recognition frames FR11, FR14, and FR12 in this order.

The technique of the embodiment specifies the right connection of the respective recognition areas in the English document P. The resulting text data obtained by character recognition of these recognition areas accordingly has high accuracy of recognition.

D. Modified Examples

Some examples of possible modification are discussed below.

(1) In the embodiment discussed above, the processing order adjustment routine shown in the flowcharts of FIGS. 5 and 6 is not activated when the recognition frames are specified manually. In a modified structure, the application window has an ‘Auto Processing Order Adjust’ button. In response to the operator's click of this ‘Auto Processing Order Adjust’ button with the mouse 20, the processing order adjustment routine starts even after manual specification of the recognition frames.

(2) The order of the determination at steps S210, S230, and S250 in the processing order adjustment routine of the embodiment may be changed according to the requirements. The determination at steps S210, S230, and S250 is not restrictive, but the determination may be carried out at only selected one or two steps among these steps S210, S230, and S250. Another modification may omit the processing of steps S210 through S250 and adjust the processing order, only based on the results of syntax analysis at step S260.

(3) In the structure of the embodiment, the recognition area specification sub-module 34a specifies recognition areas and allocates processing ordinal numbers to the specified recognition areas. The processing order adjustment sub-module 34b then reallocates the processing ordinal numbers according to the processing order adjustment routine. In one modified example, the recognition area specification sub-module 34a does not allocate the processing ordinal numbers. A processing order setting sub-module replaces the processing order adjustment sub-module 34b and carries out the determination at steps S210, S230, and S250 to successively allocate the processing ordinal numbers.

(4) In the embodiment discussed above, the target image data as the object of character recognition is image data corresponding to one page of a document optically read by the image scanner 14. The target image data may be image data of a document read from the HDD or a recording medium, such as a CD-R. The target image data may otherwise be supplied from a certain server connecting with an external network.

(5) The procedure of the embodiment specifies the two recognition areas L1 and L2, which are located on the left or right side and the lower side of the target processing area S(i), as the potential continuing recognition areas. The potential continuing recognition areas may be three recognition areas located on the left, the right, and the lower sides of the target processing area, or may be four recognition areas located on the left, the right, the lower, and the upper sides of the target processing area. Recognition areas located in the oblique direction, for example, on a lower right side or on a lower left side, may also be included in the potential continuing recognition areas. Recognition areas located in a next column but one in the downward direction, in the leftward direction, or in the rightward direction may also be included in the potential continuing recognition areas. Recognition areas located in any range having the potential for connection with the target processing area may be set to the potential continuing recognition areas. The terminology ‘neighborhood of the target processing area’ in the claims is not restricted to an immediate next to the target processing area but may be any range having the potential for connection with the target processing area.

The embodiment and its modified examples discussed above are to be considered in all aspects as illustrative and not restrictive. There may be many other modifications, changes, and alterations without departing from the scope or spirit of the main characteristics of the present invention. All changes within the meaning and range of equivalency of the claims are therefore intended to be embraced therein.

The scope and spirit of the present invention are indicated by the appended claims, rather than by the foregoing description.

What is claimed is:

1. A character recognition device that specifies multiple recognition areas in image data corresponding to one page of a document and carries out character recognition in each of the multiple recognition areas, said character recognition device comprising:
a target processing area selection module that selects one of the multiple recognition areas as a target processing area;
a first character recognition module that carries out character recognition of image data in the selected target processing area;
a second character recognition module that specifies plural recognition areas located in the neighborhood of the selected target processing area as potential continuing recognition areas and carries out character recognition of image data in each of the potential continuing recognition areas; and
a linguistic connection determination module that determines a linguistic-connection of the target processing area with each of the potential continuing recognition areas according to a relation between a character in the target processing area recognized by said first character recognition module and a character in each potential continuing recognition area recognized by said second character recognition module, and specifies a recognition area that is a linguistic continuance of the target processing area, based on a result of the determination.

2. A character recognition device in accordance with claim 1, said character recognition device further comprising:
a restriction module that restricts the potential continuing recognition areas to recognition areas having an identical dimension with that of the target processing area.

3. A character recognition device in accordance with claim 1, wherein a recognition area located on a predetermined side between left and right sides of the target processing area and a recognition area located below the target processing area are specified as the potential continuing recognition areas.

4. A character recognition device in accordance with claim 3, said character recognition device further comprising:
a writing direction specification module that specifies a writing direction of the document as either vertical writing or horizontal writing; and
a direction setting module that sets the left side to the predetermined side in the case of vertical writing specified by said writing direction specification module, while setting the right side to the predetermined side in the case of horizontal writing specified by said writing direction specification module.

5. A character recognition device in accordance with claim 1, wherein said first character recognition module recognizes a character at an end of the image data in the target processing area, and
said second character recognition module recognizes a character at a head of the image data in each of the potential continuing recognition areas.

6. A character recognition device in accordance with claim 5, wherein said linguistic connection determination module, when the character recognized by said first character recognition module is a symbol representing termination of a sentence, selects a potential continuing recognition area having a blank character recognized by said second character recognition module and specifies the selected potential continuing recognition areas as the recognition area that is a linguistic continuance of the target processing area.

7. A character recognition device in accordance with claim 5, wherein said linguistic connection determination module, when the character recognized by said first character recognition module is not a symbol representing termination of a sentence and is located at an edge of the target processing area, selects a potential continuing recognition area having a character other than a blank character recognized by said second character recognition module and specifies the selected potential continuing recognition areas as the recognition area that is a linguistic continuance of the target processing area.

8. A character recognition device in accordance with claim 1, wherein said first character recognition module recognizes a character string in at least a preset rear range of the image data in the target processing area,
said second character recognition module recognizes a character string in at least a preset front range of the image data in each of the potential continuing recognition areas, and
said linguistic connection determination module comprises a syntax analysis sub-module that tentatively connects the character string recognized by said first character recognition module with the character string recognized by said second character recognition module and analyzes a syntax of the character strings including the connection, so as to determine a linguistic connection of the target processing area with each of the potential continuing recognition areas.

9. A character recognition device in accordance with claim 8, wherein said linguistic connection determination module further comprises:
a presence determination sub-module that, when an end of the character string recognized by said first character recognition module is not a symbol representing termination of a sentence but is located at an edge of the target processing area, determines whether there is any potential continuing recognition area having a character other than a blank character at a head of the character string recognized by said second character recognition module, and
said syntax analysis sub-module is activated when it is determined that there is no potential continuing recognition area by said presence determination sub-module.

10. A character recognition device in accordance with claim 1, said character recognition device further comprising:
a processing order data storage module that stores data for defining a processing order of character recognition of the multiple recognition areas; and
a processing order adjustment module that modifies the data to adjust the processing order, based on a result of the determination by said linguistic connection determination module,
wherein said target processing area selection module successively changes selection of the target processing area in the processing order defined by the data stored in said processing order data storage module.

11. A character recognition method that specifies multiple recognition areas in image data corresponding to one page of a document and carries out character recognition in each of the multiple recognition areas, said character recognition method comprising the steps of:
(a) selecting one of the multiple recognition areas as a target processing area;
(b) carrying out character recognition of image data in the selected target processing area;
(c) specifying plural recognition areas located in the neighborhood of the selected target processing area as potential continuing recognition areas and carrying out character recognition of image data in each of the potential continuing recognition areas; and
(d) determining a linguistic connection of the target processing area with each of the potential continuing recognition areas according to a relation between a character in the target processing area recognized in said step (b) and a character in each potential continuing recognition area recognized in said step (c), and specifying a recognition area that is a linguistic continuance of the target processing area, based on a result of the determination.

12. A recording medium in which a computer program is recorded in a computer readable manner, said computer program being executed to specify multiple recognition areas in image data corresponding to one page of a document and to carry out character recognition in each of the multiple recognition areas, said computer program causing a computer to attain the functions of:
(a) selecting one of the multiple recognition areas as a target processing area;
(b) carrying out character recognition of image data in the selected target processing area;
(c) specifying plural recognition areas located in the neighborhood of the selected target processing area as potential continuing recognition areas and carrying out character recognition of image data in each of the potential continuing recognition areas; and
(d) determining a linguistic connection of the target processing area with each of the potential continuing recognition areas according to a relation between a character in the target processing area recognized in said function (b) and a character in each potential continuing recognition area recognized in said function (c), and specifying a recognition area that is a linguistic continuance of the target processing area, based on a result of the determination.

13. A recording medium in accordance with claim 12, wherein said computer program further causes the computer to attain the functions of:
(e) restricting the potential continuing recognition areas to recognition areas having an identical dimension with that of the target processing area.

14. A recording medium in accordance with claim 12, wherein a recognition area located on a predetermined side between left and right sides of the target processing area and a recognition area located below the target processing area are specified as the potential continuing recognition areas.

15. A recording medium in accordance with claim 14, wherein said computer program further causes the computer to attain the functions of:
(f) specifying a writing direction of the document as either vertical writing or horizontal writing; and
(g) setting the left side to the predetermined side in the case of vertical writing specified by said function (f), while setting the right side to the predetermined side in the case of horizontal writing specified by said function (f).

16. A recording medium in accordance with claim 12, wherein said function (b) recognizes a character at an end of the image data in the target processing area, and
said function (c) recognizes a character at a head of the image data in each of the potential continuing recognition areas.

17. A recording medium in accordance with claim 16, wherein said function (d), when the character recognized by said function (b) is a symbol representing termination of a sentence, selects a potential continuing recognition area having a blank character recognized by said function (c) and specifies the selected potential continuing recognition areas as the recognition area that is a linguistic continuance of the target processing area.

18. A recording medium in accordance with claim 16, wherein said function (d), when the character recognized by said function (b) is not a symbol representing termination of a sentence and is located at an edge of the target processing area, selects a potential continuing recognition area having a character other than a blank character recognized by said function (c) and specifies the selected potential continuing recognition areas as the recognition area that is a linguistic continuance of the target processing area.

19. A recording medium in accordance with claim 12, wherein said function (b) recognizes a character string in at least a preset rear range of the image data in the target processing area,
said function (c) recognizes a character string in at least a preset front range of the image data in each of the potential continuing recognition areas, and
said function (d) comprises the sub-function of:
(d-1) tentatively connecting the character string recognized by said function (b) with the character string recognized by said function (c) and analyzing a syntax of the character strings including the connection, so as to determine a linguistic connection of the target processing area with each of the potential continuing recognition areas.

20. A recording medium in accordance with claim 19, wherein said function (d) comprises the sub-function of:
(d-2) when an end of the character string recognized by said function (b) is not a symbol representing termination of a sentence but is located at an edge of the target processing area, determining whether there is any potential continuing recognition area having a character other than a blank character at a head of the character string recognized by said function (c), and
said sub-function (d-1) is activated when it is determined that there is no potential continuing recognition area by said sub-function (d-2).

21. A recording medium in accordance with claim 12, wherein said computer program further causes the computer to attain the functions of:
(h) storing data for defining a processing order of character recognition of the multiple recognition areas; and
(i) modifying the data to adjust the processing order, based on a result of the determination by said function (d), and
said function (a) successively changes selection of the target processing area in the processing order defined by the data stored by said function (h).
